(19) United States
(12) Patent Application Publication
(10) Pub. No.: US 2008/0100191 A1
(43) Pub. Date: May 1, 2008

(54) Insertion-Type Light Source Device

(76) Inventors: Mang Ou-Yang, Hsinchu (TW); Shih-Wei Huang, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/553,472

(22) Filed: Oct. 27, 2006

(51) Int. Cl. H01K 1/26

(52) U.S. Cl. 313/113

(57) ABSTRACT

An insertion-type light source device comprises a light source having a filament mounted on a base and a handle extended from the base, and an envelope, which is an integrally molded hollow body composed of at least two concave reflectors, having a light outlet and an opening for inserting the filament of the light source into an interior of the envelope. The light source is replaceable by means of removing the light source from the envelope through the opening. After the light source is completely inserted, the light source is positioned correctly relative to the reflectors of the envelope without calibration. In use, a user can hold the handle of the light source to prevent the whole device from contamination.

### BACKGROUND OF THE INVENTION

1. Field of the Invention

The present invention relates to an insertion-type light source device, and in particular to an insertion-type light source device which is easy to assemble and position the filament in an envelope, and has high light delivery efficiency and low contamination.

2. The Prior Arts

Basically, the principle of a projection displayer is similar to that of all projectors. The projector casts light on an image-displaying component to generate images, and then the images are projected through a lens onto a screen. The image-displaying component includes two types: a transmissive type which lets light pass through a transparent piece to project the resulting image onto the screen, and a reflective type which shines the light on an object to project the resulting image onto the screen. Both types split the light into red, green and blue, and then generate images of various colors. Because one component can display only one color, three components are required to generate three single-colored images. The three images are merged into one image through a prism, and then projected through a lens to a screen.

The light source of a video projector is similar to those employed in transparency projectors, projection displaying devices, rear projection TV's, slide projectors, light engines, automotive lamps and household lighting device; however, after years of development, problems still exist.

For example, an envelope of a reflector that is capable of reflecting light in a specific direction is provided in WO 2005/017406 METHOD OF MANUFACTURING REFLECTOR, LIGHTING APPARATUS, AND PROJECTOR. The method is heating a tubular mold having a smooth central portion, and extending a surface of a central reflector after gas is filled in. The tubular envelope is cut in two halves to obtain two reflector envelopes. A small smooth reflector is added in the envelope to enhance the light utilization efficiency with a low manufacturing cost.

The disadvantages associated with the aforementioned invention are as below. (1) When the light source needs to be replaced, the whole set including the light bulb, the envelope with the reflectors as well as peripheral fastening members, has to be replaced, even though the latter two are still working. (2) The electroplated reflective area of the reflector is reduced due to the assembly requirement, which causes part of the light unable to be collected. (3) The filament extends longitudinally, which results in uneven light output. (4) The requirement of the plural reflector components results in a higher manufacturing cost than a single-reflector envelope.

U.S. Pat. No. 6,356,700 discloses another projector lamp system, which employs an arc lamp as the light source thereof and utilizes a hemispherical reflector and an elliptical reflector to reflect light. A filament is disposed at a focal point of the elliptical reflector, which is proximate to the elliptical surface of the reflector. The focal point is also the center of the hemispherical reflector. The hemispherical reflector reflects the light to the center thereof, which is also the focal point of the elliptical reflector. The light is then reflected to another focal point of the elliptical reflector by the elliptical reflector to be used in projection. The light collection method increases the light utilization efficiency and obtains a more even light source than those utilizing a conventional parabolic or elliptical reflector.

However, the aforementioned system has the following disadvantages. (1) When the light source is replaced, the position of the filament must be calibrated relative to the envelope. It is hard to place the filament at the focal point. (2) The replacement procedure of the light source is complicated which has to disassemble the two reflectors first and calibrate the positions of the reflectors after the filament is replaced. (3) The assembly method reduces the electroplated area of the reflector; as a result, part of the light cannot be collected. (4) To replace the light source, the whole device has to be disassembled, which is likely to contaminate the reflector and the filament tube. If the reflector or the filament tube is contaminated, the projection efficiency of the whole device will be greatly reduced. (5) The heat generated by the filament may not be dissipated easily, which shortens the life thereof. (6) The requirement of a plurality of reflectors results in a higher manufacturing cost than a single-reflector envelope. (7) The double-reflector envelope has size larger than a single-reflector envelope does.

In short, conventional light sources of projection devices utilize parabolic or elliptical reflectors to collect light, which has a common drawback of uneven light projection. The filament tube is in the direction of the projected light, and does not emit light in an axial direction. Therefore it results in a dim area at a center of projection area. Therefore, highly efficient light engines are proposed to solve this problem. However, the filament of the light engine is completely enclosed within two reflectors. Once the filament fails, the whole device has to be disassembled to replace the light source. To disassemble the whole device may contaminate the reflector and the filament tube, which may hinder the heat dissipation of the device and disperse the light emitted, and increase difficulty of calibration when the device is reassembled.

### SUMMARY OF THE INVENTION

A primary objective of the present invention is to provide an insertion-type light source device, in which a filament tube is replaceable by means of inserting the filament tube into an envelope, wherein no calibration is required regarding to the position of a filament relative to two reflectors of the envelope.

A further objective of the present invention is to provide an insertion-type light source device, wherein the light source includes a handle for facilitating the replacement so that the whole device will not be contaminated.

A still further objective of the present invention is to provide an insertion-type light source device, in which an axis of the light emitted by the light source is perpendicular to the filament tube to eliminate the dim area in a center of projection area.

An even further objective of the present invention is to provide an insertion-type light source device, in which two electrodes are at the same end of the tube. Due to only one opening being provided for insertion of the light source, an electroplated area of a reflector is increased. The light utilization efficiency is greatly enhanced. In addition, because the two reflectors are integrally molded, the calibration is unnecessary when reassembled. The manufacturing cost is reduced as well.

Accordingly, the insertion-type light source device in accordance with the present invention comprises at least a light source having a filament mounted on a base and a handle extended from the base, and an envelope, which is an integrally molded hollow body, having a light outlet and an opening for inserting the filament of the light source into an interior of the envelope.

When the light source and the envelope are assembled together, the light source is held by an operator to insert the filament tube through the opening of the envelope into the interior of the envelope. After the filament is completely inserted into the envelope, the filament is approximately aligned with the light outlet of the envelope.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a projector utilizing an insertion-type light source device in accordance with the present invention;

FIG. 2 is a schematic view showing an insertion-type light source device in accordance with a first embodiment of the present invention;

FIG. 3 is a schematic view showing an insertion-type light source device in accordance with a second embodiment of the present invention;

FIG. 4 is a schematic view showing an insertion-type light source device in accordance with a third embodiment of the present invention;

FIG. 5 is a schematic view showing an insertion-type light source device in accordance with a forth embodiment of the present invention; and

FIG. 6 is a schematic view showing an insertion-type light source device in accordance with a fifth embodiment of the present invention.

### DETAILED DESCRIPTION OF THE PREFERRED EMBODIMENT

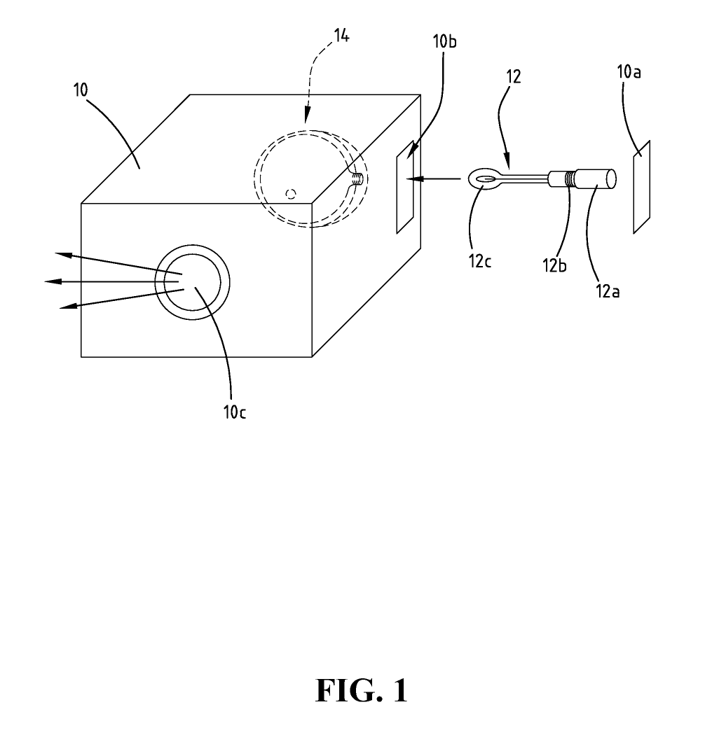

With reference to FIG. 1, the projector 10 comprises a lid 10a, an opening 10b, a projector lens 10c and an insertion-type light source device, which has a light source 12 and an envelope 14. The envelope 14 is installed inside the projector 10 and fastened by a fastening member (which is not limited to any specific structure as long as it fastens the envelope 14). The envelope 14 aligns with the opening 10b and the lid 10a. The light source 12 includes a filament 12c mounted on a base 12b. A handle 12a is extended from the base 12b. When a user installs the light source 12, he or she lifts the lid 10a to insert or screw the light source 12 into the envelope 14 through the opening 10b.

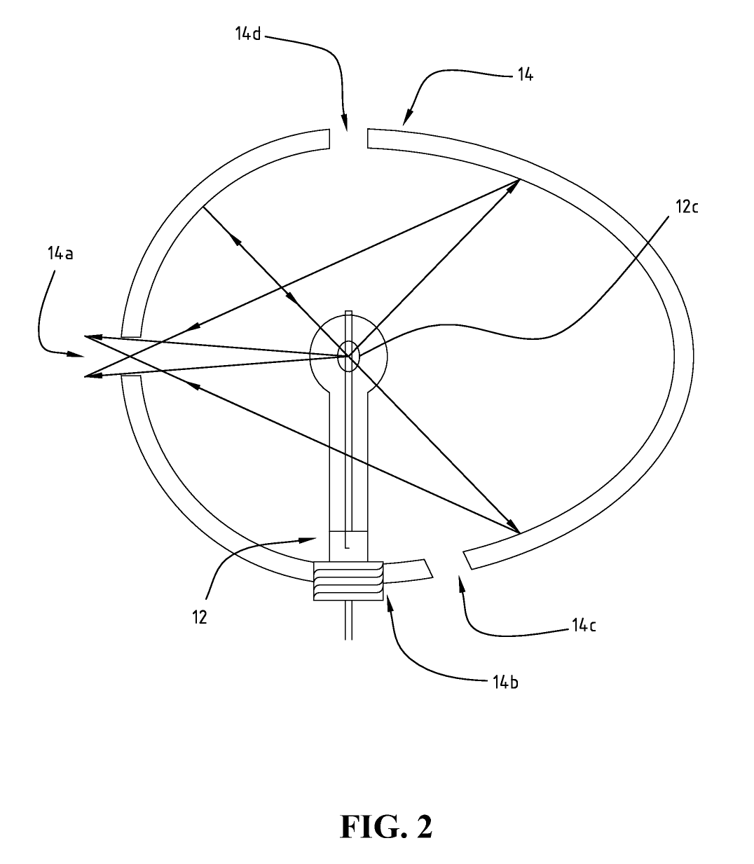

With reference to FIG. 2, an insertion-type light source device in accordance with a first embodiment of the present invention comprises a light source 12 and an envelope 14. The envelope 14, which is an integrally molded hollow body composed of at least two concave reflectors, has a light outlet 14a to let light pass through and an opening 14b for inserting the light source 12 into an interior of the envelope 14. Vents 14c and 14d may be further provided on the envelope 14, which serve as outlet for air and enhance the heat dissipation efficiency.

When the light source 12 is installed, a user holds the handle 12a of the light source 12 to pass through the opening 14b and insert the light source 12 into the interior of the envelope 14. After the filament 12c is completely inserted into or screwed into the envelope 14, the filament 12c approximately aligns with the light outlet 14a and the projector lens 10c. On the other hand, when the light source 12 is replaced, the user holds the handle 12a and turn in a reverse direction to remove the light source 12 from the envelope 14. Therefore, it does not need to disassemble the projector 10 to install or replace the light source 12, thereby preventing inner components of the projector 10 from contamination. At the same time, the user holds the handle 12a of the light source 12 without touching the filament 12c, which prevents the filament 12c from contamination as well. Besides, the handle 12a may have a grooved or granulated surface for easy installation or removal of the light source 12.

When the light source 12 is working, in addition to part of the light projected through the light outlet 14a directly, part of the light is reflected by inner walls of the envelope 14 to pass through the light outlet 14a. In other words, among the plurality of concave reflectors on the inner walls of the envelope 14, the concave reflector with the light outlet 14a reflects the light emitted by the light source 12 through where the light source 12 is located, and the other concave reflector reflects the light to the light outlet 14a. Therefore the light is converged and projected out through the light outlet 14a.

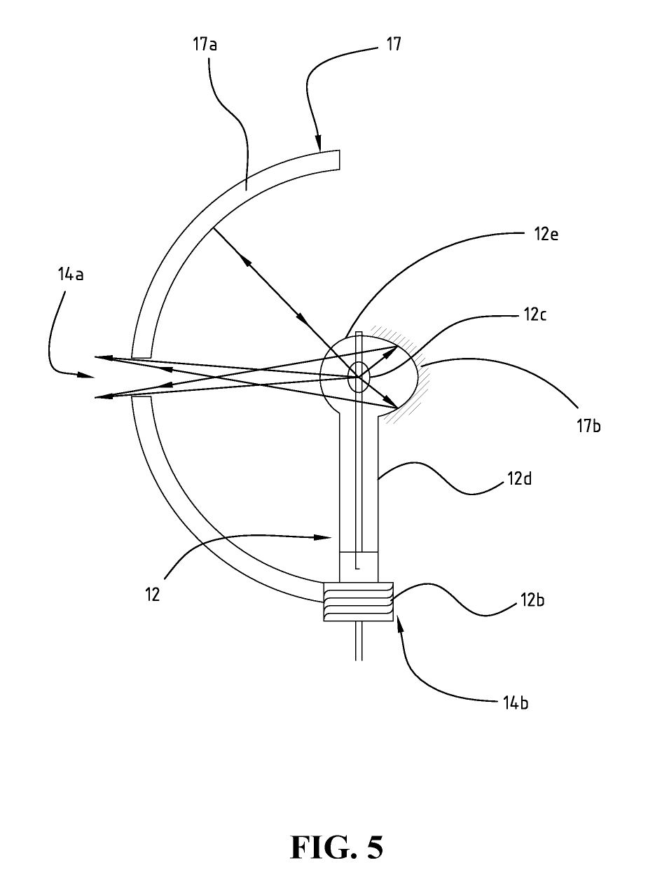

The axis of the light emitted by aforementioned light source 12 is perpendicular to a filament tube 12d (as shown in FIG. 5), which eliminates a dim area in a center of projection area. The light source 12 may be one of a light emitting diode (LED), a laser diode (LD), a light bulb and a light tube. The light source 12 has both electrodes at the same end thereof. Therefore, the light source 12 can be inserted into the envelope 14 without disassembling the envelope 14. The light source 12 includes heat dissipating electrodes (e.g. copper electrodes) located at the joint of the filament tube 12d and the envelope 14 to serve for electrical conducting and heat dissipating functions simultaneously.

Besides, an inner surface of the envelope 14 may be in any concave shape and is electroplated with a reflective material to enhance the reflection effect, increase the rate of light passing through the light outlet 14a, and enhance light utilization efficiency.

To firmly connect the light source 12 with the envelope 14, the base 12b of the light source 12 includes a fastening member for engagement with a fastening member provided on opening 14b of the envelope 14. The fastening members may be a spring tenon/mortise set, a rotation tenon/mortise set, or screw threads (as shown in FIGS. 1-6). A rim of the opening 14b of the envelope 14 is made of an insulating material, e.g. ceramic. With the aforementioned fastening member, the relative position of the envelope 14 and the filament 12c is predetermined. When the light source 12 is inserted into the envelope 14, the positions of the filament 12c of the light source 12 and the envelope 14 does not need to be calibrated. Besides, the fastening members also assist the installation and replacement of the light source 12.

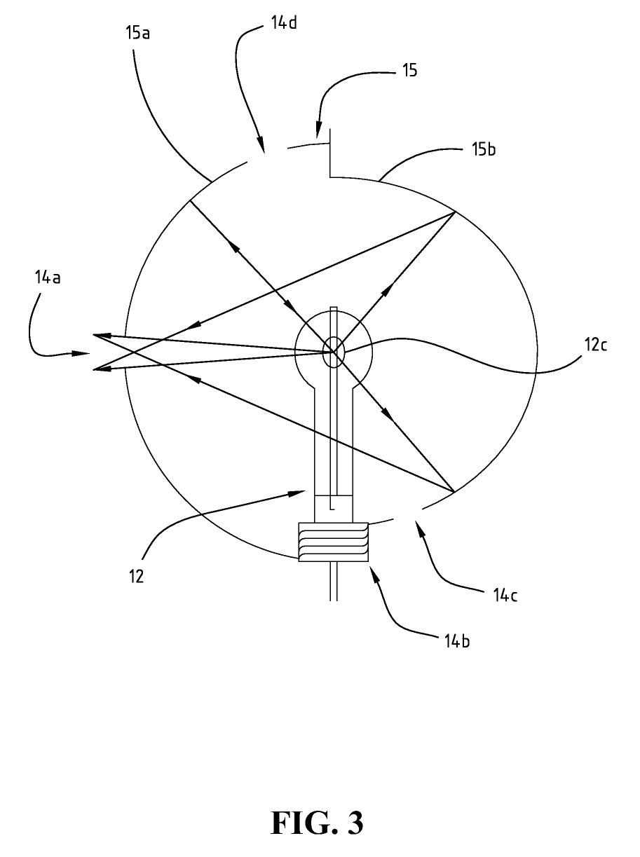

With reference to FIG. 3, an insertion-type light source device in accordance with a second embodiment of the present invention comprises a light source 12 and an envelope 15. The envelope 15 composed of a concave reflector 15a in conjunction with an elliptical reflector 15b, has a light outlet 14a provided on the concave reflector 15a, and an opening 14b provided between the concave reflector 15a and the elliptical reflector 15b. To enhance the heat dissipation efficiency, vents 14c and 14d may be further included in the envelope 15.

When the light source 12 is installed with the envelope 15, the user can hold a handle 12a of the light source 12 to insert the light source 12 into the interior of the envelope 15 through the opening 14b. After a filament 12c is completely inserted into the envelope 15, the filament 12c approximately aligns with the light outlet 14a

The difference between the first embodiment and the second embodiment is that the elliptical reflector 15b used in the second embodiment replaces the concave reflector 14 used in the first embodiment. After adjusting curvatures of the concave reflector 15a and the elliptical reflector 15b, the concave reflector 15a and the elliptical reflector 15b increase the rate of light passing through the light outlet 14a.

When the light source 12 is working, the electroplated concave reflector 15a reflects the light emitted by the light source 12 through where the light source 12 is located, and then the electroplated elliptical reflector 15b reflects the light to the light outlet 14a. Therefore the light is converged and projected out through the light outlet 14a.

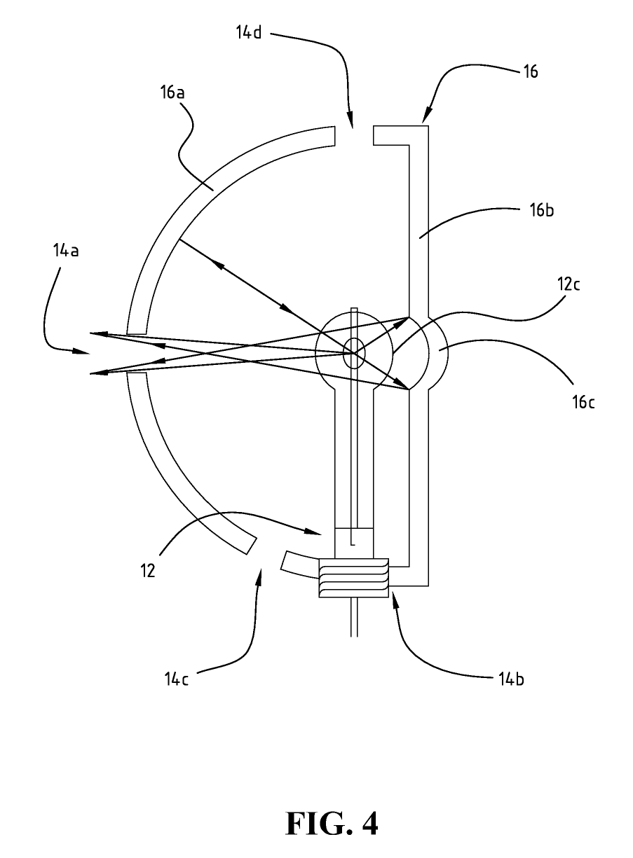

With reference to FIG. 4, an insertion-type light source device in accordance with a third embodiment of the present invention comprises a light source 12 and an envelope 16. The envelope 16 is composed of a concave reflector 16a and a planar reflector 16b. The planar reflector 16b has an elliptical reflector 16c recessed at a center thereof. A light outlet 14a is provided on the concave reflector 16a, and an opening 14b is provided between the concave reflector 16a and the planar reflector 16b. To enhance the heat dissipation effect, the envelope 16 may further include vents 14c and 14d. When the light source 12 is working, the light is reflected by the elliptical reflector 16c, which is very close to the filament 12c, and projected out through the light outlet 14a.

With reference to FIG. 5, an insertion-type light source device in accordance with a fourth embodiment of the present invention comprises a light source 12, an envelope 17, and a filament tube 12d having a concave portion 12e proximate to the filament 12c. The filament tube 12d encloses the filament 12c and is fastened on the base 12b. Part of a surface of the concave portion 12e is electroplated with a reflective material 17b to serve as a reflector.

When the light source 12 is working, the surface of the concave portion 12e with an electroplated reflective material 17b is capable of reflecting the light emitted by the filament 12c without obstructing it, and projecting the light out through the light outlet 14a of the envelope 17.

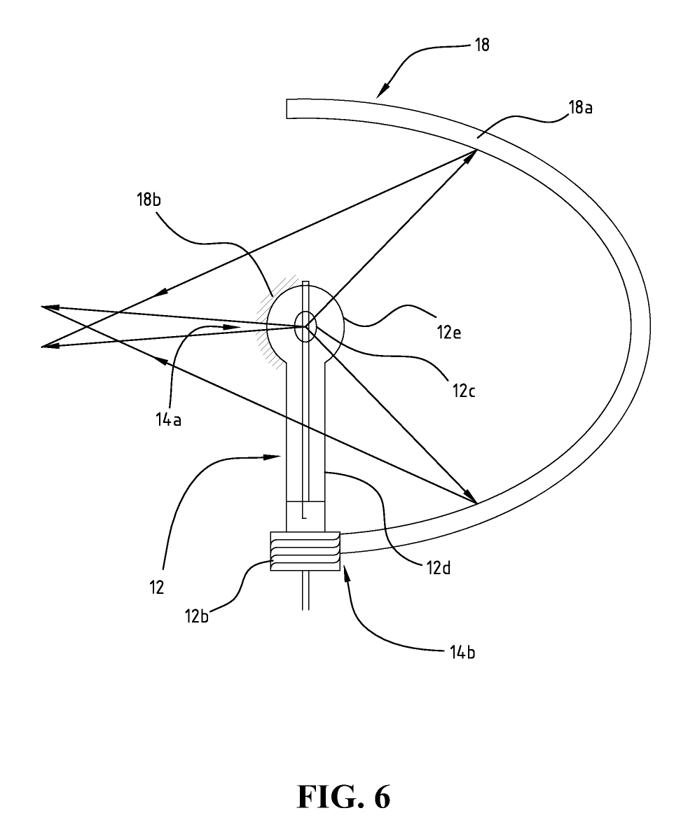

With reference to FIG. 6, an insertion-type light source device in accordance with a fifth embodiment of the present invention comprises a light source 12, an envelope 18, and a filament tube 12d having a concave portion 12e proximate to the filament 12c. The filament tube 12d encloses the filament 12c and fastens on the base 12b.

Similar to the fourth embodiment, the concave portion 12e of the fifth embodiment has a reflective material 18b electroplated on part of a surface thereof. A primary difference between these two embodiments is where the electroplated reflective material 17b or 18b is located. The electroplated reflective material 17b is located at rear part of the concave portion 12e and projects light out through the light outlet 14a in the fourth embodiment. The electroplated reflective material 18b is located at front part of the concave portion 12e and reflects light back to the envelope 18 in the fifth embodiment. Another difference between these two embodiments is that a light outlet 14a is defined on envelope 17 in fourth embodiment while the light outlet 14a is defined on the reflective material 18b on the concave portion 12e in the fifth embodiment.

When the light source is working, part of the light emitted by the filament 12c is projected out directly through the light outlet 14a, part of the light is reflected to a concave reflector 18a of the envelope 18 by the reflective material 18b and part of the light emitted by the filament 12c is projected on the concave reflector 18a directly. All the light projected on the concave reflector 18a is then reflected out to the projector lens 10c.

In both the fourth and the fifth embodiments, a reflector may replace the reflective material 17b or 18b.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An insertion-type light source device, comprising
a light source including a filament mounted on a base and a handle extended from the base; and
an envelope having an integrally molded hollow body composed of at least two concave reflectors, having a light outlet to let light pass through, an opening for inserting the filament of the light source into an interior of the envelope, and at least one vent for dissipating heat from the interior of the envelope, wherein part of the concave reflectors reflect light emitted by the light source through where the light source is located, while part of the concave reflectors reflect the light to the light outlet, so that the light is capable of being converged and projected out through the light outlet;
wherein the light source is inserted into the envelope through the opening, whereby the filament of the light source approximately aligns with the light outlet after the light source is completely inserted into the envelope, and the concave reflector is one of a reflecting mirror and an inner surface of the envelope electroplated with a reflective material.

2. The light source device as claimed in claim 1, wherein the envelope composed of a concave reflector in conjunction with an elliptical reflector has the light outlet to let light pass through, the concave reflector reflects the light emitted by the light source through where the light source is located, while the elliptical reflector reflects the light to the light outlet, so that the light is capable of being converged and projected out through the light outlet.

3. The light source device as claimed in claim 1, wherein the envelope composed of a concave reflector in conjunction with a planar reflector having an elliptical reflector recessed at the center thereof, the concave reflector reflects the light emitted by the light source through where the light source is located, while the planar reflector reflects the light to the light outlet, so that the light is capable of being converged and projected out through the light outlet.

4. The light source device as claimed in claim 1, wherein the base of the light source includes a fastening member for engagement with a fastening member provided on the opening of the envelope for fixing the light source with the envelope.

5. The light source device as claimed in claim 4, wherein the fastening member is one of a spring tenon/mortise set, a rotation tenon/mortise set and screw threads.

6. The light source device as claimed in claim 1, wherein a rim of the opening of the envelope is made of an insulating material.

7. The light source device as claimed in claim 1, wherein the light source has both electrodes at the same end thereof.

8. The light source device as claimed in claim 1, wherein the light source is one of a light emitting diode (LED), a laser diode (LD), a light bulb and a light tube.

9. The light source device as claimed in claim 1, wherein the handle has one of a grooved surface and a granulated surface.

10. An insertion-type light source device, comprising
a light source including a filament mounted on a base and a handle extended from the base;
a filament tube having a transparent tube body, enclosing the filament, fastened on the base, and having a concave portion close to the filament, wherein the concave portion has a concave reflector on part of a surface thereof for reflecting the light; and
an envelope having a concave reflector, including a light outlet located near the center thereof to let light pass through, an opening located near a periphery thereof for inserting the filament of the light source into an interior of the envelope, and at least one vent for dissipating heat from the interior of the envelope;
wherein the light source is inserted in the envelope through the opening, whereby the filament of the light source approximately aligns with the light outlet after the light source is completely inserted into the envelope, the concave reflector of the envelope is one of a reflecting mirror and a surface electroplated with a reflective material, and the concave reflector of the concave portion is one of a reflecting mirror and a surface electroplated with a reflective material.

11. The light source device as claimed in claim 10, wherein the filament tube has an elliptical concave portion proximate to the filament, and an elliptical reflector of the elliptical concave portion reflects the light to the light outlet of the envelope while the concave reflector of the envelope reflect the light emitted by the light source through where the light source is located.

12. The light source device as claimed in claim 10, wherein the filament tube has a spherical concave portion proximate to the filament, a hemispherical reflector of the spherical concave portion reflects the light emitted by the light source to the envelope, and the spherical concave portion has a light outlet formed thereon to let light pass through; and the envelope is an elliptical reflector converging and projecting the light out of the insertion-type light source device.

13. The light source device as claimed in claim 10, wherein the base of the light source includes a fastening member for engagement with a fastening member provided on the opening of the envelope for fixing the light source with the envelope.

14. The light source device as claimed in claim 13, wherein the fastening member is one of a spring tenon/mortise set, a rotation tenon/mortise set and screw threads.

15. The light source device as claimed in claim 10, wherein a rim of the opening of the envelope is made of an insulating material.

16. The light source device as claimed in claim 10, wherein the light source has both electrodes at the same end thereof.

17. The light source device as claimed in claim 10, wherein the light source is one of a light emitting diode (LED), a laser diode (LD), a light bulb and a light tube.

18. The light source device as claimed in claim 10, wherein the handle has one of a grooved surface and a granulated surface.
